(19) United States
(12) Patent Application Publication
(10) Pub. No.: US 2008/0256165 A1
(43) Pub. Date: Oct. 16, 2008

(54) Full-Adder Modules and Multiplier Devices Using the Same

(75) Inventor: Rohini Krishnan, Folsom, CA (US)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 12/065,633

(22) PCT Filed: Sep. 4, 2006
(86) PCT No.: PCT/IB06/53099

§ 371 Date: Apr. 28, 2008

(30) Foreign Application Priority Data
Sep. 5, 2005 (EP) 05108124.8
Sep. 4, 2006 (IB) PCT/IB2006/053099

(51) Int. Cl. G06F 7/501

(52) U.S. Cl. 708/703

(57) ABSTRACT

A full-adder module (30) comprises a full-adder comprising a plurality of input and output terminals, a sum generation unit and a carry generation unit. The carry generation unit comprises a programmable inverter arranged to selectively invert a carry-in bit to the carry generating unit in response to a control signal applied to one of the input terminals. The full-adder module (30) provides an area-efficient logic block that supports signed multiplications, the logic block retaining its programmable nature and being capable of performing all the other operations it was intended to perform.

This invention relates to signed multiplication operations for semiconductor integrated circuits, and in particular to full-adder-based array multipliers for use in programmable hardware such as Field Programmable Gate Arrays (FPGAs).

Multiplication is the most common operation in signal processing. Designing fast and area efficient multipliers has been a topic of considerable research. Very compact and high-speed multipliers for Application Specific Integrated Circuits (ASICs) already exist, which are capable of handling both signed and un-signed numbers.

However, efficiently implementing multiplication on existing programmable hardware solutions, such as Field Programmable Gate Arrays (FPGAs), has remained a challenge. More particularly, when the well-known multiplication algorithms are mapped onto programmable logic blocks present on the FPGAs, a large number of logic blocks are needed to accomplish an n-bit multiplication. This is because the logic blocks in FPGAs are designed to be general, such that they can implement any random function and are not specifically suited for accomplishing multiplication.

Another challenge is to be able to perform direct two's complement multiplication (or signed multiplication) on FPGAs. Conventionally, signed multiplication is performed using the Booth recording technique, which was proposed by Booth in “A Signed Binary Multiplication Technique”, Quarterly Journal of Mechanics and Applied Mathematics, Vol. IV, part 2, 1951. This technique works very efficiently when application specific hardware is synthesised for this purpose. However, it is well-known that if the hardware does not directly implement the Booth multiplication, and if general programmable blocks (like in FPGAs) are used to perform Booth multiplication, there is an area overhead because of the many conditional tests, branches and arithmetic shifting that needs to be implemented.

In re-configurable devices, a conventional method of performing signed multiplication is to first convert the signed number into an unsigned number, perform unsigned multiplications, for example through array multiplication, and then re-convert the result into the appropriate signed representation (two's complement). Although this approach provides partial re-usability, it requires additional logic blocks to perform the conversion and re-conversion step, thus involving area and speed penalties for its implementation.

Array multipliers are most suited for FPGAs, since they accomplish the multiplication by a series of additions in an array-fashion. Because most logic blocks in FPGAs already support addition, the implementation of an array-multiplier is quite simple.

Two common types of array multipliers are known as carry-ripple array multipliers (described in “Computer Arithmetic: Principles, Architecture, and Design”, K. Hwang, John Wiley and Sons, New York, 1979) and Pezaris carry-save array multipliers (described in “A Universal Pezaris Array Multiplier Generator for SRAM-Based FPGAs”, J. Stohman & E. Barke, IEEE International Conference on Computer Design, 1997, Pages 489-495).

The general multiplication scheme of an array multiplier consists of two units: the first implementing the partial products (summands); and the second performing the summand summation. In a carry-ripple multiplier the carry signals go horizontally, whereas in a carry-save multiplier the carry signals go diagonally. Generally, the Pezaris carry-save array multiplier is favoured for its regular routing pattern and speed since carry-save adders are inherently faster than carry-ripple adders.

To directly perform two's complement operations, the summation unit of a Pezaris carry-save multiplier is based on four different full-adder types (as detailed further on).

In practice, implementation of a Pezaris array multiplier does not involve changing the logic-block structure of the FPGA to better support signed multiplications, rather it involves mapping the Pezaris array multiplier on the existing FPGA again involving area and speed penalties.

Many commercial FPGAs have tried to solve this problem by providing hard-macros inside their chips that are dedicated to performing wide multiplications (e.g. 18 bit×18 bit, both signed and un-signed). These hard-macros cannot be used for performing any other kind of operation and are only available at a limited number of fixed positions in the array. It is therefore desirable to realise an area efficient hardware unit within the logic-block structure of an FPGA that can be used not only for signed (and unsigned) multiplication, but also for performing addition and subtraction.

According to an aspect of the invention, there is provided a full-adder module comprising a full-adder comprising a plurality of input and output terminals, a sum generation unit and a carry generation unit, wherein the carry generation unit comprises a programmable inverter arranged to selectively invert a carry-in bit to the carry generating unit in response to a control signal applied to one of the input terminals.

Thus, there is provided an area-efficient logic block that supports signed multiplications. The logic block retains its programmable nature and is also capable of performing all other operations.

Due to the minimal hardware extension involved, the invention enables direct-signed multiplications to be implemented more efficiently on array multipliers.

The invention can reduce the logic-block count by up to 35% by avoiding the need to convert two's complement numbers into their unsigned equivalents, multiply in the unsigned domain and re-convert back to two's complement representation.

The invention can be applied to the implementation of signed multiplication in the form of an array multiplier. It is particularly suited to performing signed multiplication on FPGA logic blocks or systolic arrays.

The invention thus also relates to the use of a plurality of full-adder modules of the invention within an array multiplier.

The plurality of full-adder modules can be arranged in an interconnected array as a Pezaris carry-save array multiplier; and the type of addition performed by each full-adder module is selected in response to the control signal applied to each full-adder module. Alternatively, they may be arranged in an interconnected array as a carry-ripple array multiplier; and the type of addition performed by each full-adder module is selected in response to the control signal applied to each full-adder module.

Embodiments of the invention will now be described, by way of example only, with reference to the following diagrams wherein:

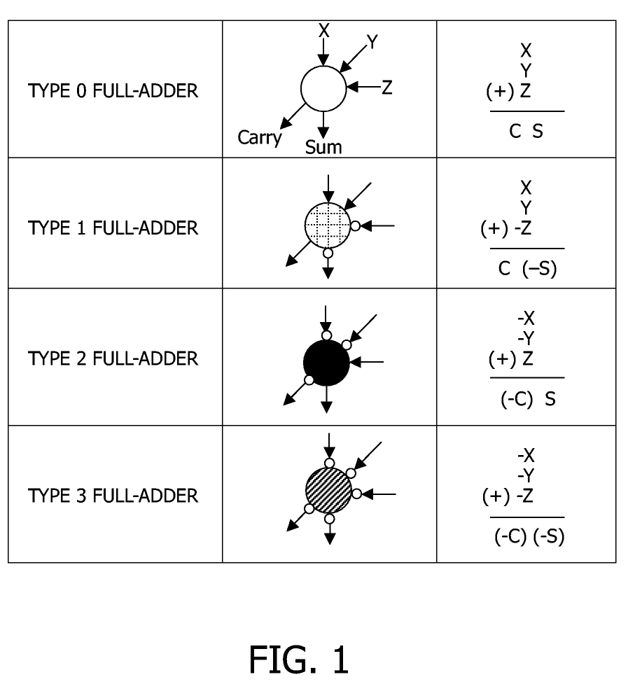

FIG. 1 is a table illustrating the four types of full-adders used in conventional array multipliers;

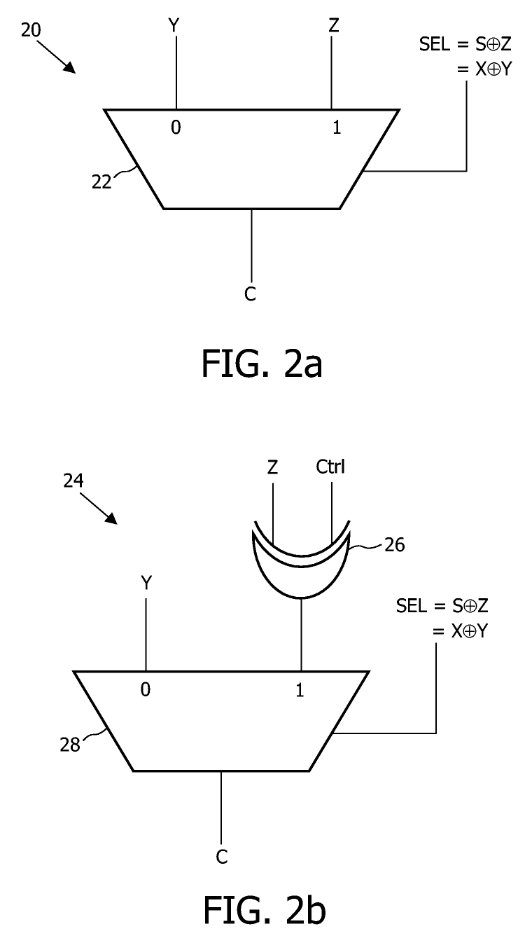

FIG. 2a is a schematic diagram of a conventional Carry-Generation Unit of a conventional full-adder;

FIG. 2b is a schematic diagram of a Carry-Generation Unit according to an embodiment of the invention;

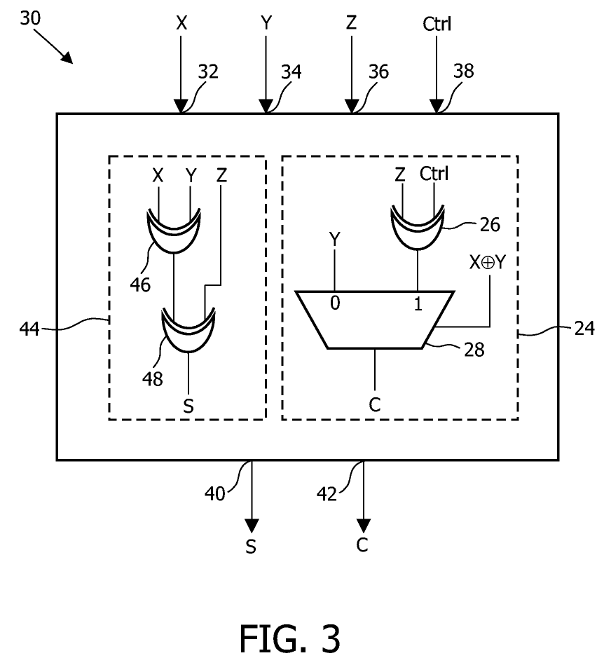

FIG. 3 is a schematic diagram of a full-adder module according to another embodiment of the invention;

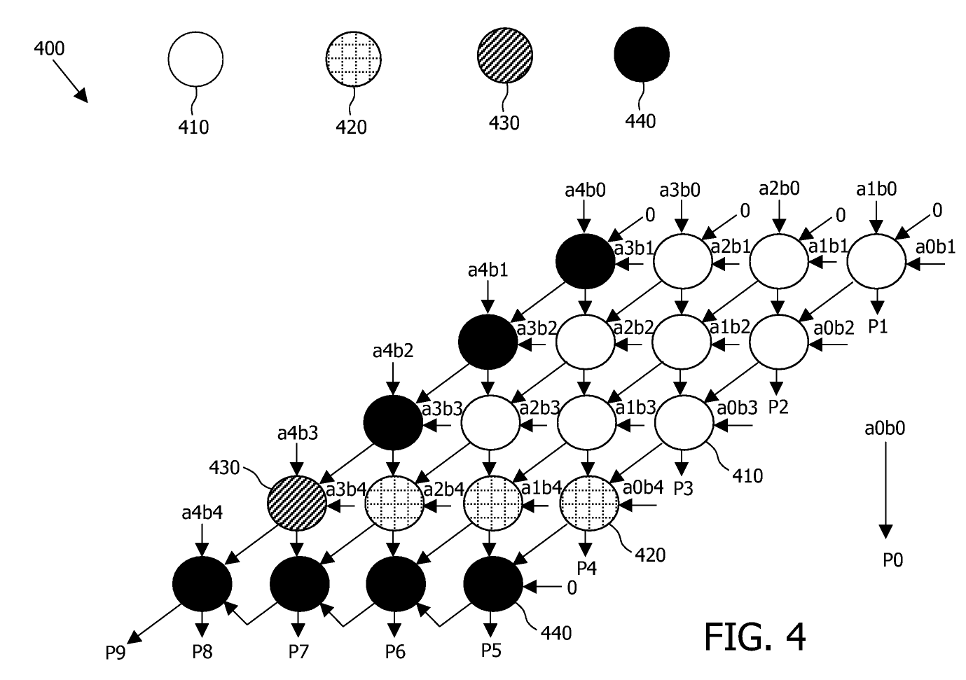

FIG. 4 is a schematic diagram of an array multiplier according to yet another embodiment of the invention; and

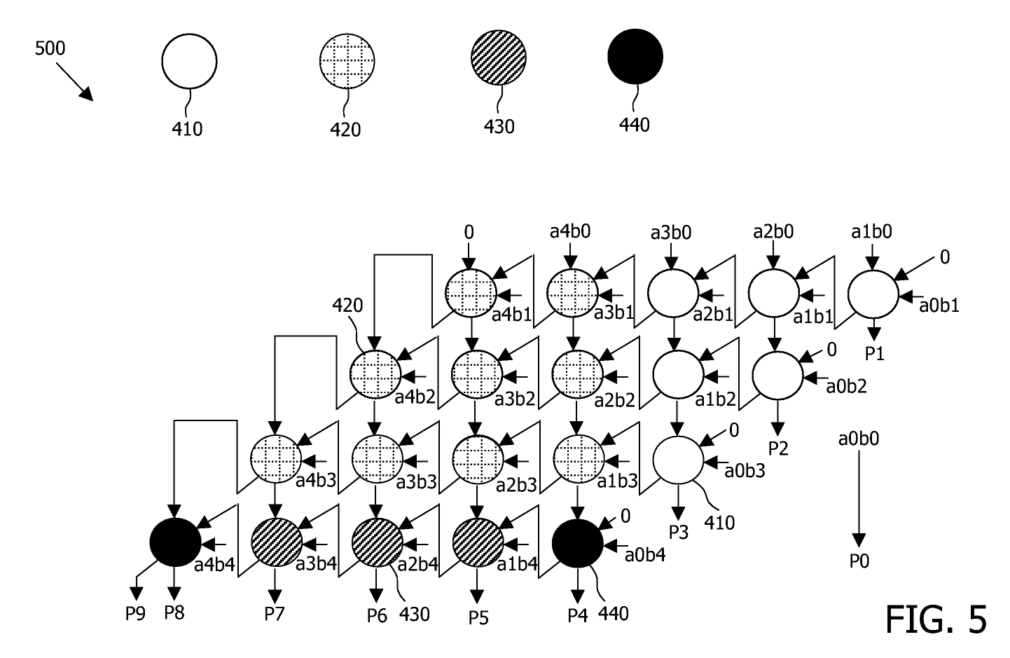

FIG. 5 is a schematic diagram of an array multiplier according to yet another embodiment of the invention.

The present invention is now to be further explained by way of describing various embodiments of the invention. While the present invention is susceptible of embodiment in various forms, there are described and shown in the drawings presently preferred embodiments. These embodiments are provided so that the disclosure will be thorough and complete, and will fully convey the scope of the invention to those skilled in the art. Like reference numerals refer to like elements throughout.

Conventional full-adders are known in the art and generate a sum (S) and a carry (C) output from three Boolean inputs, X, Y, and a carry-in (Z). Also, none of the inputs or outputs is inverted in a conventional full-adder. The sum and carry outputs for a conventional full-adder may be described as Equations 1 (Eqs. 1):

S=X⊕Y⊕Z;

C= (̅S̅⊕̅Z̅)̅Y+(S⊕Z)Z (Eqs. 1)

Conventional carry-ripple array-multipliers and Pezaris carry-save array multipliers comprise an array of full-adders, the full-adders implementing one of four types of addition, Type 0, Type 1, Type 2, and Type 3. Referring to FIG. 1, a table illustrating the four types of full-adders used in conventional array multipliers is shown.

A Type 0 full-adder generates a sum (S) output and a carry (C) output from three Boolean inputs, X, Y, and a carry-in (Z). None of the inputs or outputs is inverted. Thus, a Type 0 full-adder is equivalent to a conventional full-adder.

A Type 1 full-adder also generates a sum (S) output and a carry (C) output from three Boolean inputs, X, Y, and Z (carry-in). However, the Z (carry-in) input and the sum output (S) are both inverted.

In a Type 2 full-adder, a sum (S) output and a carry (C) output are generated from three Boolean inputs, X, Y, and Z (carry-in), the X and Y inputs and the carry (C) outputs being inverted.

A Type 3 full-adder generates a sum (S) and a carry (C) output from three Boolean inputs, X, Y, and a Z (carry-in), all of the inputs and outputs being inverted.

The expressions for the sum (S) and carry (C) outputs for both Type 0 and Type 3 full-adders may therefore be described as Equations 2 (Eqs. 2):

S=X⊕Y⊕Z;

C= (̅S̅⊕̅Z̅)̅Y+(S⊕Z)Z (Eqs. 2)

Further, the expressions for the sum (S) and carry (C) outputs for both Type 1 and Type 2 full-adders may be described as Equations 3 (Eqs. 3):

S=X⊕Y⊕Z;

C= (̅S̅⊕̅Z̅)̅Y+(S⊕Z) Z̅ (Eqs. 3)

It can observed from the above equations that the carry (C) output of both Type 1 and Type 2 full-adders differ from that of a conventional full-adder.

Referring to FIG. 2a, a schematic diagram of a conventional Carry-Generation Unit (CGU), indicated generally by 20, of a conventional full-adder is shown. The CGU comprises a 2:1 multiplexer 22 that has its first and second signal terminals respectively connected to a first Boolean input (Y) and a second Boolean input (Z). The selection terminal of the multiplexer 22 is connected to a signal that may be described by the equation S⊕Z. The multiplexer 22 selects the second Boolean input (Z) when a potential at the selection terminal of the multiplexer 22 is at a high (1) level, and selects the first Boolean input (Y) when the potential at the selection terminal of the multiplexer 22 is at a low level (0). The signal selected by the multiplexer 22 is output as the carry signal (C).

The conventional CGU 20 generates the carry signal (C) as described in Equations 1 and 2, and therefore may be implemented within Type 0 and Type 3 full adders. However, it has been appreciated by the inventor that a conventional CGU may also be used to generate the carry signal (C) of Type 1 and Type 2 full adders by inverting the second Boolean input (Z).

Referring to FIG. 2b, a schematic diagram of a CGU, indicated generally by 24, according to an embodiment of the invention is shown. The CGU 24 comprises a two-input XOR logic gate 26 and a 2:1 multiplexer 28.

The two-input XOR logic gate 26 has one of its inputs connected to a Boolean input (Z) and the other of its inputs connected to a control signal (Ctrl). The XOR logic gate 26 acts as a programmable inverter by outputting the complement of the Boolean input (Z) when the potential of the control signal (Ctrl) is at a high level (1).

Alternatively, the programmable inverter can be implemented with any such suitably arranged component(s), for example a multiplexer that has the function and its complement as inputs and can be programmed to choose either of the inputs by a selection signal.

The multiplexer 28 has its first and second signal terminals respectively connected to a second Boolean input (Y) and the output of the two input XOR logic gate 26. The selection terminal of the multiplexer 28 is connected to a signal that may be described by the equation S⊕Z. The multiplexer 28 selects the output of the two input XOR logic gate 26 when a potential at the selection terminal of the multiplexer 22 is at a high (1) level, and selects the second Boolean input (Y) when the potential at the selection terminal of the multiplexer 22 is at a low level (0). The signal selected by the multiplexer 28 is output as the carry signal (C).

When the control signal (Ctrl) is arranged to be at a low level (0), the two-input XOR logic gate 26 simply passes the Boolean signal (Z) directly to the second signal terminal of the multiplexer 28. Thus, as detailed above, the multiplexer 28 generates the carry signal (C) as described in Equations 1 and 2.

When the control signal (Ctrl) is arranged to be at a high level (1), the two-input XOR logic gate 26 acts as a programmable inverter, outputting the complement of the Boolean signal (Z) to the second signal terminal of the multiplexer 28. The multiplexer 28 therefore generates the carry signal (C) as described in Equations 3.

Thus, the CGU 24 may be used to generate the carry signal (C) of the four types of full-adder (Type 0, Type 1, Type 2, Type 3), when the control signal (Ctrl) is arranged such that it is high (1) for Type 1 and Type 2 additions and low (0) for Type 0 and Type 3 additions.

Referring to FIG. 3, a schematic diagram of a full-adder module according to the invention is shown, the full adder being indicated generally by 30. The full-adder 30 comprises first to fourth input terminals 32,34,36,38, first and second output terminals 40,42, a Sum-Generating Unit (SGU) 44, and a CGU 24.

The SGU 44 is a conventional SGU used in conventional full-adders. The SGU 44 comprises first and second two-input XOR logic gates 46,48. The first XOR gate 46 has one of its inputs connected to the first input terminal 32 and the other of its inputs connected to the second input terminal 34. The second XOR gate 48 has one of its inputs connected to the output of the first XOR gate 46 and the other of its inputs connected to the third input terminal 36. The output of the second XOR logic gate 36 is connected to the first output terminal 40. Thus, the SGU 44 generates the sum (S) as described in Equations 1 and outputs it to the first output terminal 40.

The CGU 24 is as described above. The XOR gate 26 has one of its inputs connected to the third input terminal 36 and the other of its inputs connected to the fourth input terminal 38. The multiplexer 28 has its first and second signal terminals respectively connected to a the second input terminal 34 and the output of the two input XOR logic gate 26. The selection terminal of the multiplexer 28 is connected to a signal that may be described by the equation X⊕Y (=S⊕Z), the selection terminal of the multiplexer 28 being connected to output of the first XOR gate 46 of the SGU 44. The signal selected by the multiplexer 28 is connected to the second output terminal 42. Thus, the carry signal (C) generated by CGU 24 may be described as Equation 4 (Eq. 4):

C= (̅S̅⊕̅Z̅)̅Y+(S⊕Z)(Z⊕Ctrl) (Eqs. 4)

As described above, the CGU 24 may therefore be used to generate the carry signal (C) of the four types of full-adder (Type 0, Type 1, Type 2, and Type 3), when the control signal (Ctrl) is arranged such that it is high (1) for Type 1 and Type 2 additions and low (0) for Type 0 and Type 3 additions.

The full adder 30 may, therefore, be used for any of the four types of addition (Type 0, Type 1, Type 2, Type 3), the type of addition being selected according to the control signal (Ctrl) applied to the fourth input terminal.

Referring to FIG. 4, a schematic diagram of an array multiplier according to the invention is shown, the array multiplier being indicated generally by 400. The array multiplier 400, which can be used inside the logic block of an SRAM-based FPGA, comprises a plurality of modified full adders according to the invention in an interconnected array, arranged to calculate the product terms from the input data. Two 5-bit two's complement numbers, A=a₄a₃a₂a₁a₀ and B=b₄b₃b₂b₁b₀, where a₄ and b₄ are the negative weights, have values described by Equations 5 (Eqs. 5):

$${A}_{decimal} = - {a}_{4} {2}^{4} + {\sum }_{i = 0}^{3} {a}_{i} {2}^{i} \\ {B}_{decimal} = - {b}_{4} {2}^{4} + {\sum }_{i = 0}^{3} {b}_{i} {2}^{i} \qquad ( Eqs . 5 )$$

Their product, P=P₉P₈P₇P₆P₅P₄P₃P₂P₁P₀, can be calculated by using the array multiplier 400, which is an interconnected array of full-adder modules arranged as a Pezaris carry-save array multiplier.

Each of the full adders has a modified CGU 24 and control signal (Ctrl) input as described above such that they can perform any of the four types of addition (Type 0, Type 1, Type 2, Type 3), the type of addition being selected according to the control signal (Ctrl).

The potential of the control signal applied to full-adder modules 410 is arranged to be low (0) such that full-adder modules 410 act as Type 0 full-adders.

The potential of the control signal applied to full-adder modules 420 is arranged to be high (1) such that full-adder modules 420 act as Type 1 full-adders.

The potential of the control signal applied to full-adder modules 430 is arranged to be high (1) such that full-adder modules 430 act as Type 2 full-adders.

The potential of the control signal applied to full-adder modules 440 is arranged to be low (0) such that full-adder modules 440 act as Type 3 full-adders.

The control signal is generated during initialization of the adder by a dedicated generator. This dedicated generator does not restrict the flexibility since it is identical to the generation of control bits when initializing adders, subtractors or unsigned multipliers.

Alternatively, the interconnected array may be arranged as a carry-ripple array multiplier 500, as illustrated in FIG. 5.

As is known in the art, both positive and negative operands should be properly sign-extended when required and sign extension is not affected by this invention. For example, when 7 (0111) is multiplied by −8 (1000), the result should be −56 (11001000). When using an 8 bit×8 bit multiplier, 7 and −8 must be sign-extended so that 7 is represented as 00000111 and −8 is represented as 11111000. From the 16 bit result obtained, only the lower 8 bits need to be considered.

The array multiplier performs signed multiplications and, unlike prior art implementations of array multipliers, the specifics of the algorithm have been used to modify the CGU inside the logic block of an FPGA. The logic blocks incorporating the proposed carry-generation-unit (CGU) are homogeneous in nature. This homogeneity eases implementation of the FPGA.

When used inside the logic block of an SRAM based-FPGA, a Look-up table (which is a set of memory cells) can be used for storing the truth-table of the desired function, for example the first XOR gate 46 of the SGU 44, or XOR gate 26 of the modified CGU 24.

The addition of the XOR gate 26 in the CGU 24 makes each CGU slightly bigger, but this area increase is much smaller than the increase in area that would be required if separate logic blocks were used to convert and negate the results for signed multiplications.

Investigations have shown that the invention realizes a logic-block area saving of roughly 35% when compared to unsigned multiplications and additions.

The proposed CGU, without losing its generality, performs the signed multiplications more efficiently.

In summary, the invention has shown that a direct two's complement signed multiplication is possible by adding a single exclusive-or gate in the carry-generation unit of traditional unsigned array multipliers. This result holds for both carry-save and carry-ripple multipliers.

It should be noted that the above-mentioned embodiments illustrate rather than limit the invention, and that those skilled in the art will be able to design many alternative embodiments without departing from the scope of the claims.

For example, any suitably arranged apparatus, such as an SRAM block, may provide the control signal to the full-adder module.

1. A full-adder module comprising:
a full-adder comprising a plurality of input and output terminals, a sum generation unit and a carry generation unit, wherein
the carry generation unit comprises a programmable inverter arranged to selectively invert a carry-in bit to the carry generating unit in response to a control signal applied to one of the input terminals.

2. A full-adder module according to claim 1, wherein the programmable inverter is a XOR logic gate.

3. A full-adder module according to claim 1, wherein the programmable inverter is a multiplexer, the multiplexer having its input signals connected to a signal and the complement of the signal and being arranged to output one of the input signals in response to the control signal.

4. A full-adder module according to claim 1, wherein the programmable inverter is arranged to invert the carry-bit when the full adder module is performing Type 1 or Type 2 additions.

5. A full-adder module according to claim 1, wherein the control signal is generated during initiation of the full-adder.

6. A full-adder module according to claim 5, wherein a dedicated generator generates the control signal.

7. An array multiplier comprising a plurality of full-adder modules according to claim 1 wherein:
the plurality of full-adder modules are arranged in an interconnected array as a Pezaris carry-save array multiplier; and
the type of addition performed by each full-adder module is selected in response to a control signal applied to each full-adder module.

8. An array multiplier comprising a plurality of full-adder modules according to claim 1 wherein:
the plurality of full-adder modules are arranged in an interconnected array as a carry-ripple array multiplier; and
the type of addition performed by each full-adder module is selected in response to a control signal applied to each full-adder module.
